(19) United States
(12) Patent Application Publication
(10) Pub. No.: US 2025/0098628 A1
(43) Pub. Date: Mar. 27, 2025

(54) PET TRAINING PAD

(71) Applicant: FOUR PAWS PRODUCTS, LTD., Neptune City, NJ (US)

(72) Inventors: Glen S. AXELROD, Colts Neck, NJ (US); Ajay GAJRIA, Monmouth Junction, NJ (US)

(21) Appl. No.: 18/897,964

(22) Filed: Sep. 26, 2024

Related U.S. Application Data
(60) Provisional application No. 63/585,397, filed on Sep. 26, 2023.

(51) Int. Cl. A01K 1/01

(52) U.S. Cl. CPC A01K 1/0107

(57) ABSTRACT

A pet training pad comprising a central region; a perimeter region which surrounds the central region and forms a periphery of the pet training pad; an absorbent material; a plurality of sloping channels which slope downward from the perimeter region to the central region; and wherein the central region has a greater weight of the absorbent material per unit area than the perimeter region.

### CROSS-REFERENCE TO RELATED APPLICATIONS

This non-provisional patent application claims the benefit of the filing date of U.S. provisional patent application Ser. No. 63/585,397, filed Sep. 26, 2023, the entire disclosure of which is incorporated by reference, to an extent consistent therewith.

### FIELD

The present disclosure is generally related to a pet training pad. More specifically, the present disclosure is related to a pet training pad that provides an absorbent (top) surface with a plurality of channels to direct a flow of pet waste, e.g. pet urine and/or feces, towards a central region of the training pad, particularly for absorption. The central region includes a relatively higher amount, e.g. greater amount by weight per unit area (weight/area), of absorbent material relative to other locations of the training pad.

### BACKGROUND

Pet owners often housetrain pets such that the pet does not urinate and/or defecate at an undesirable location within the owner's home. In some situations, a pet may not be able to get outside of the owner's home to relieve itself. To address such situations, a pet owner may train their pet to urinate and/or defecate at a consistent location within their home, such as an absorbent pet training pad. Such training pads are configured to protect underlying surfaces from urine and feces.

While pet training pads are widely used and can be effective, preventing the pet urine and/or feces deposited on the training pad from flowing over the edges of the training pad remains a problem. When a pet uses such a pet training pad, the deposited urine and/or feces, but particularly the urine, is apt to flow and may result in urine and/or feces flowing over the edges of the training pad and onto the adjacent surface of the owner's home.

### SUMMARY

The present disclosure provides a pet training pad which includes a central region that contains a relatively higher amount, e.g. greater amount by weight per unit area (weight/area), of absorbent material relative to other locations of the training pad, as well as a contour which directs fluid towards the central region. More particularly, the central region of pad is configured to contain a relatively higher amount of absorbent material, such as the superabsorbent polymer, than other locations of the training pad. In this manner, fluid directed toward the central region of the training pad encounters a location where there is relatively more absorbent material for uptake of urine or other waste fluid.

In at least one embodiment, a pet training pad comprises a central region; a perimeter region which surrounds the central region and forms a periphery of the pet training pad; an absorbent material; a plurality of sloping channels which slope downward from the perimeter region to the central region; and wherein the central region has a greater weight of the absorbent material per unit area than the perimeter region.

In at least one embodiment, the pet training pad further comprises a peripheral edge; and wherein the plurality of sloping channels which slope downward from the perimeter region to the central region slope downward from the peripheral edge to the central region.

In at least one embodiment, the plurality of sloping channels which slope downward from the perimeter region to the central region extend through the central region.

In at least one embodiment, the pet training pad further comprises a central point within the central region; and wherein the plurality of sloping channels which slope downward from the perimeter region to the central region slop downward to the central point.

In at least one embodiment, the plurality of sloping channels which slope downward from the perimeter region to the central region converge towards the central region.

In at least one embodiment, the plurality of sloping channels which slope downward from the perimeter region to the central region and converge towards the central region converge in the perimeter region.

In at least one embodiment, the plurality of sloping channels which slope downward from the perimeter region to the central region and converge towards the central region converge in the central region.

In at least one embodiment, the pet training pad further comprises a central point within the central region; wherein the plurality of sloping channels which slope downward from the perimeter region to the central region slope downward to the central point; and wherein the plurality of sloping channels which slope downward from the perimeter region to the central region converge to the central point.

In at least one embodiment, the pet training pad further comprises a top surface; and wherein the plurality of sloping channels which slope downward from the perimeter region to the central region are formed in the top surface.

In at least one embodiment, the pet training pad further comprises a peripheral edge and a central point within the central region; and wherein the plurality of sloping channels which slope downward from the perimeter region to the central region slope downward continuously from the peripheral edge to the central point.

In at least one embodiment, the plurality of sloping channels which slope downward from the perimeter region to the central region slope down at an angle in a range of 5° to 40°.

In at least one embodiment, the pet training pad has a top surface area; and wherein the central region defines up to 40.0% of the top surface area of the pet training pad.

In at least one embodiment, the pet training pad has a top surface area; and wherein the central region defines 10.0% to 40.0% of the top surface area of the pet training pad.

In at least one embodiment, the absorbent material comprises a super absorbent polymer.

In at least one embodiment, the pet training pad has a concave contour towards the central region.

In at least one embodiment, the pet training pad further comprises a top surface; wherein the plurality of sloping channels comprise adjacent channels; and wherein the top surface has a convex contour between the adjacent channels such that a fluid disposed on the convex contour will flow towards at least one of the adjacent channels.

In at least one embodiment, the pet training pad further comprises an impermeable bottom layer which is impermeable to waste fluid of a pet.

In at least one embodiment, the perimeter region surrounds the central region completely as to form a continuous loop around the central region.

In at least one embodiment, the pet training pad has a peripheral edge and the perimeter region forms the peripheral edge completely.

In at least one embodiment, a method of using a pet training pad is provided, comprising obtaining the pet training pad, the pet training pad comprising a central region; a perimeter region which surrounds the central region and forms a periphery of the pet training pad; an absorbent material; a plurality of sloping channels which slope downward from the perimeter region to the central region; and wherein the central region has a greater weight of the absorbent material per unit area than the perimeter region; placing the pet training pad on a planar support surface; and disposing a fluid on a top surface of the pet training pad such that the fluid flows in at least one of the plurality of sloping channels towards the central region.

### FIGURES

The above-mentioned and other features of this disclosure, and the manner of attaining them, will become more apparent and better understood by reference to the following description of embodiments described herein taken in conjunction with the accompanying drawings, wherein:

FIG. 1 is a top (plan) view of a pet training pad according to the present disclosure;

FIG. 2 is a perspective view of the pet training pad of FIG. 1.

FIG. 3 is a cross sectional perspective view of the pet training pad of FIG. 2;

FIG. 4 is a cross sectional side view of an alternative sloping channel of the pet training pad of FIG. 1;

### DETAILED DESCRIPTION

It may be appreciated that the present disclosure is not limited in its application to the details of construction and the arrangement of components set forth in the following description or illustrated in the drawings. The invention(s) herein may be capable of other embodiments and of being practiced or being carried out in various ways. Also, it may be appreciated that the phraseology and terminology used herein is for the purpose of description and should not be regarded as limiting as such may be understood by one of skill in the art.

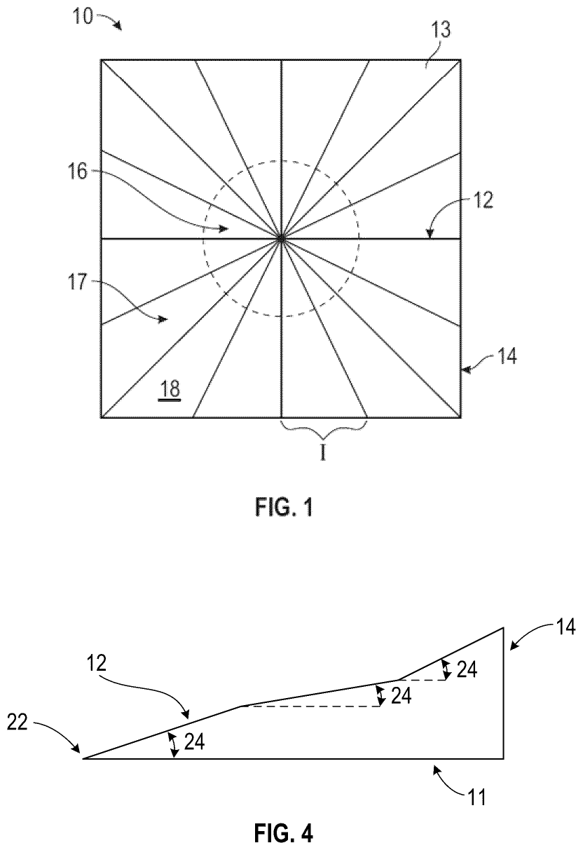

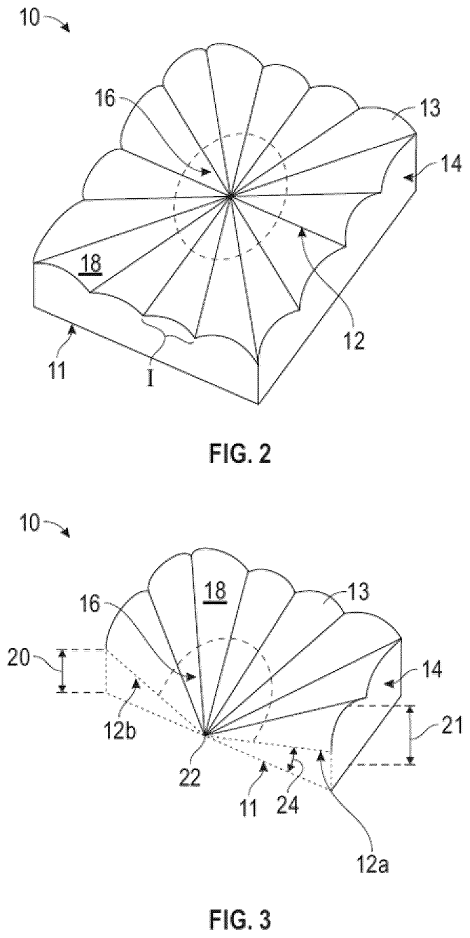

Referring now to the figures, FIG. 1 is a top view of a preferred embodiment of a pet training pad 10 the present disclosure, while FIG. 2 is a complete perspective view of the pet training pad 10 and FIG. 3 is a partial (cross-sectional) perspective view of the pet training pad 10. FIG. 4 is an alternative embodiment of a sloping channel of the pet training ped of the disclosure.

As shown, the pet training pad 10 may have one or more outer (peripheral) edges 14. The pet training pad 10 may have four equal length edges thereby forming a square, however, the pet training pad 10 may take on other various geometries (e.g., rectangle, circle, polygon, etc.).

As best shown by FIG. 3, the pet training pad 10 has a top surface 18 with a downward sloping (concave) contour towards a central region 16 and a central point 22, and a plurality of sloping channels 12 present between raised (convex) portions 13 of the pad surface 18. The sloping channels 12 are therefore present as a plurality of channels 12, and preferably spaced at intervals I along the outer (peripheral) edges 14 of the pet training pad 10.

From the outer (peripheral) edges 14, the plurality of sloping channels 12 continuously slope downwards and converge into the central region 16, and more particularly the central point 22, of the pet training pad 10. Namely, the sloping channels 12 define a sloping pathway from the outer (peripheral) edges 14 of the pet training pad 10 into the central region 16. The central region 16 may have a cross dimension, measured across the top surface 18 of the pet training pad 10, such as a diameter, in a range from 3 inches to 15 inches, while the pet training pad 10 may be square with a length of 18 to 28 inches and a width of 18 to 28 inches. The sloping channels 12 may have a length from the outer (peripheral) edge 14 to the central point 22 in a range of 9 to 20 inches, and more particularly 12 inches to 17.

The intervals I at which the sloping channels 12 originate along the outer (peripheral) edges 14 of the pet training pad 10 may be random or based on a selected geometric pattern. For example, in the preferred embodiment shown in FIGS. 1-2, the intervals I at which the sloping channels 12 originate may be equally spaced along the outer (peripheral) edges 14 of the pet training pad 10.

In addition, the pet training pad 10 also includes a non-central (perimeter) region 17. As shown, the non-central (perimeter) region 17 at least partially surrounds the central region 16, as well as at least partially defines an outer (peripheral) edge 14 of the pet training pad 10. As shown, the non-central (perimeter) region 17 completely surrounds the central region 16 as to form a continuous loop around the central region 16, as well as completely defines the outer (peripheral) edge 14 of the ped training pad 10.

The central region 16 is a region in the pet training pad 10 that preferably contains a relatively higher amount, e.g. greater amount by weight per unit area (weight/area), of an absorbent material than in the non-central (perimeter) region 17, such as an superabsorbent polymer. The superabsorbent polymer may have, for example, a retention absorbency in a range of 30 g/g to 45 g/g; an absorption capacity in a range of 55 g/g to 65 g/g (as measured in a 0.9% NaCl aqueous solution); an absorption rate (e.g., a quantity of time to absorb 50, 100, or 150 milliliters of liquid such as a 0.9% NaCl aqueous solution) in a range of 15 seconds to 40 seconds; a moisture content in a range of 4% to 9%; a measure of residual acrylic acid monomers in a range of 15 parts-per-million (ppm) to 25 ppm; and a bulk density in a range of 0.6 g/ml to 0.85 g/ml.

By way of a further example, the superabsorbent polymer may have a retention absorbency of 41 g/g; an absorption capacity of 60 g/g (as measured in a 0.9% NaCl aqueous solution); an absorptive rate of 29 seconds; a moisture content of 7.4%; a measure of residual acrylic acid monomers of 22 ppm; and a bulk density of 0.74 g/ml. By way of still further example, the superabsorbent polymer may have a retention rate of 40 g/g; an absorption capacity of 60 g/g (as measured in a 0.9% NaCl aqueous solution); an absorption rate of 30 seconds; a moisture content of 7.2%; a measure of residual acrylic acid monomers of 18 ppm; and a bulk density of 0.74 g/ml. Particle sizes of the superabsorbent polymer may measure less than 850 microns (μm). For example, between 80% and 90% of the particles may have a particle size measuring in a range of 180 μm to 500 μm.

Preferably, the central region 16 is a closed (circular) area such that it defines up to 40.0% of the surface area of the pet training pad 10, such as top surface 18, where bodily waste fluids may be disposed. In other words, as illustrated in FIG. 1, the central region 16 where there is a relatively higher amount, e.g. greater amount by weight per unit area (weight/area), of absorbent material as compared to the non-central (perimeter) region 17, is present within the pet training pad 10 at such location and preferably below the top surface 18. Therefore, in preferred embodiment, up to 40% of the available surface area of the training pad 10, such as top surface 18, is now overlying a central region 16 where there is a relatively high amount of absorbent material.

Additionally, the central region 16 may also define a more limited central region such as 35%, 30%, 25%, 20%, 15%, or 10% of the available surface area of the top surface 18. Accordingly, within central region 16, one can preferably increase the relative density of the absorbent material so that the density of the absorbent material, within central region 16 is increased. This in turn provides for relatively higher absorption capacity of any waste bodily fluids in central region 16 as compared to non-central (perimeter) region 17, and such waste bodily fluids are also now promoted to flow into such central region having higher absorption capacity.

FIG. 2 depicts the preferred embodiment of FIG. 1 in a perspective view. FIG. 3 shows a cross section of the training pad 10 of FIG. 2 along two sloping exemplary channels 12a, 12b. As can be seen in FIG. 3, the thickness 20 of pet training pad 10 at and along the channels 12a, 12b—where the thickness 20 of the pet training pad 10 is measured from the bottom non-permeable layer 11 to the top surface 18 of the pet training pad 10, preferably decreases from the outer (peripheral) edge 14 of the pet training pad 10 to the central region 16 of the pet training pad 10. More particularly, the thickness 20 of pet the training pad 10 at and along the channels 12a, 12b continually decreases from the outer (peripheral) edge 14, through the non-central (perimeter) region 17 as well as through the central region 16, to the central point 22 of the pet training pad 10 where the channels 12 all intersect.

In addition, as shown, the thickness 21 of the pet training pad 10 between adjacent channels 12 is thicker than the thickness 20 of the pet training pad 10 at the channels 12, with the thickness 21 of the pet training pad 10 between the adjacent channels 12 also continually decreasing from the outer (peripheral) edge 14, through the non-central (perimeter) region 17 as well as through the central region 16, to the central point 22 of the pet training pad 10 where the channels 12 all intersect. As shown, the top surface 18 and thickness 21 of the pet training pad 10 between adjacent channels 12 has a convex contour, to promote the flow of waste bodily fluids disposed on the top surface 18 towards at least one of the adjacent channels 12.

By way of example, the thickness of the central region 16 of the pet training pad 10, may be in a range of 0.020 inches to 0.60 inches. More particularly, the thickness at the center point 22 may be in a range of 0.02 inches to 0.08 inches, while the thickness adjacent the non-central (perimeter) region 17 may be in a range of 0.12 inches to 0.675. The thickness of the non-central (perimeter) region 17 adjacent the central region may be in a range of 0.12 inches to 0.675 inches, while the thickness at the outer (peripheral) edge 14 may be 0.25 inches to 1.25 inch.

Accordingly, this provides a plurality of sloping channels 12 to promote the flow of waste bodily fluids toward the central region 16 of the pet training pad 10. Preferably, the sloping channels 12 are downwardly sloped towards the central region 16 of the pet training pad 10 at an angle 24 (with the central point 22 shown as the apex of the angle 24) in the range of 5° to 40°, including all individual values and increments therein. Accordingly, the sloping channels 12 may be downwardly sloping towards the central region 16 of the pet training pad 10, and more particularly to the central point 22, at an angel 24 of 5°, 6°, 7°, 8°, 9°, 10°, 11°, 12°, 13°, 14°, 15°, 16°, 17°, 18°, 19°, 20°, 21°, 22°, 23°, 24°, 25°, 26°, 27°, 28°, 29°, 30°, 31°, 32°, 33°, 34°, 35°, 36°, 37°, 38°, 39° or 40°. While the angle 24 may be shown in FIGS. 2-3 to be same from the outer (peripheral) edge 14 to the central point 22, it should be understood that the downward slope may change along the length of the channels 12 from the outer (peripheral) edge 14 to the central point 22, thus resulting in more than one angle being utilized, such as shown in FIG. 4.

The plurality of sloping channels 12 may preferably be provided by quilting in the training pad 10. Quilting refers to impressions which selectively compress the thickness of the training pad 10. The quilting may be configured as one or more impressions along the length of each one of the plurality of channels 12. For example, the quilting may be a single solid line impression along the length of each one of the plurality of channels 12. Alternatively, the quilting may be a plurality of relatively smaller consecutive impressions of various shapes (e.g., dots, diamonds, dashes, etc.) spanning the length of each one of the plurality of channels 12. The quilting may be configured to provide a substantially straight (linear) channel 12. The quilting preferably provide compression to the thickness of the pet training pad 10 which is greatest in channels 12 at central surface region 16 and least where channel 12 is adjacent to the outer (peripheral) edge 14 of the pet training pad 10.

Accordingly, the overall thickness 20 of the pet training pad 10 preferably decreases incrementally, and more particularly continuously, from the outer (peripheral) edge 14 towards central surface region 16, as well as the central point 22, along the length of the channels 12 at the channels 12. Moreover, the overall thickness 21 of the pet training pad 10 also preferably decreases incrementally, and more particularly continuously, from the outer (peripheral) edge 14 towards central surface region 16, as well as the central point 22, along the length of the channels 12 between adjacent channels 12.

The incremental, and more particularly continuous, decrease in the thickness 20 of the pet training pad 10 at and along the length of the channel 12 causes the channel 12 to provide an inclined surface which as noted, starts at outer (peripheral) edges 14 and slopes downward to the central surface region 16. As noted herein, the absorbency of the pet training pad 10 is the preferably configured to be relatively greatest at the central region 16 than at other location in the pet training pad 10. Due to the sloping channels 12, and the presence of a relatively higher amount, e.g. greater amount by weight per unit area (weight/area), of absorbent material within central region 16, the pet training pad 10 herein provides relatively more efficient distribution of bodily fluid waste that comes in contact at any location on the pad surface 18.

In addition to the non-permeable bottom layer 11, which may lay substantially flat on a planar support surface (e.g. floor), the pet training pad 10 may have one or more absorbent layers, an attractant layer, a scent masking layer, and/or a non-permeable bottom layer Reference to a non-permeable (impermeable) layer 11 is reference to the feature that the layer prevents most or all urine and/or feces from passing through, which may, for example, be formed of a polymer film such as an polyolefin (e.g. polyethylene) film.

The attractant layer may include one or more attractants to encourage a pet to approach the training pad when there is a need to relieve themselves. For example, the attractant may include one or more pheromones configured to encourage the pet to urinate on the training pad. The scent masking layer may preferably cover-up odors that occur after use and reduce the amount of scent detectable by the owner.

While preferred embodiments of the present disclosure have been described, it should be understood that various changes, adaptations and modifications can be made therein without departing from the spirit of the disclosure and the scope of the appended claims. The scope of the disclosure should, therefore, be determined not with reference to the above description, but instead should be determined with reference to the appended claims along with their full scope of equivalents. Furthermore, it should be understood that the appended claims do not necessarily comprise the broadest scope of the invention(s) which the applicant is entitled to claim, or the only manner(s) in which the invention(s) may be claimed, or that all recited features are necessary.

### LIST OF REFERENCE CHARACTERS

10 pet training pad
11 bottom non-permeable layer
12 sloping channels
12a sloping channel
12b sloping channel
13 raised portions
14 outer (peripheral) edge
16 central region
17 non-central (perimeter) region
18 top surface
20 thickness at the channels
21 thickness between the channels
22 central point
24 angle
I intervals

What is claimed is:

1. A pet training pad comprising:
a central region;
a perimeter region which surrounds the central region and forms a periphery of the pet training pad;
an absorbent material;
a plurality of sloping channels which slope downward from the perimeter region to the central region; and
wherein the central region has a greater weight of the absorbent material per unit area than the perimeter region.

2. The pet training pad of claim 1, further comprising a peripheral edge; and
wherein the plurality of sloping channels which slope downward from the perimeter region to the central region slope downward from the peripheral edge to the central region.

3. The pet training pad of claim 1, wherein the plurality of sloping channels which slope downward from the perimeter region to the central region extend through the central region.

4. The pet training pad of claim 1, further comprising a central point within the central region; and
wherein the plurality of sloping channels which slope downward from the perimeter region to the central region slop downward to the central point.

5. The pet training pad of claim 1, wherein the plurality of sloping channels which slope downward from the perimeter region to the central region converge towards the central region.

6. The pet training pad of claim 5, wherein the plurality of sloping channels which slope downward from the perimeter region to the central region and converge towards the central region converge in the perimeter region.

7. The pet training pad of claim 5, wherein the plurality of sloping channels which slope downward from the perimeter region to the central region and converge towards the central region converge in the central region.

8. The pet training pad of claim 1, further comprising a central point within the central region;
wherein the plurality of sloping channels which slope downward from the perimeter region to the central region slope downward to the central point; and
wherein the plurality of sloping channels which slope downward from the perimeter region to the central region converge to the central point.

9. The pet training pad of claim 1, further comprising a top surface; and
wherein the plurality of sloping channels which slope downward from the perimeter region to the central region are formed in the top surface.

10. The pet training pad of claim 1, further comprising a peripheral edge and a central point within the central region; and
wherein the plurality of sloping channels which slope downward from the perimeter region to the central region slope downward continuously from the peripheral edge to the central point.

11. The pet training pad of claim 1, wherein the plurality of sloping channels which slope downward from the perimeter region to the central region slope down at an angle in a range of 5° to 40°.

12. The pet training pad of claim 1, wherein the pet training pad has a top surface area; and
wherein the central region defines up to 40.0% of the top surface area of the pet training pad.

13. The pet training pad of claim 1, wherein the pet training pad has a top surface area; and
wherein the central region defines 10.0% to 40.0% of the top surface area of the pet training pad.

14. The pet training pad of claim 1, wherein the absorbent material comprises a super absorbent polymer.

15. The pet training pad of claim 1, wherein the pet training pad has a concave contour towards the central region.

16. The pet training pad of claim 1, further comprising a top surface;
wherein the plurality of sloping channels comprise adjacent channels; and
wherein the top surface has a convex contour between the adjacent channels such that a fluid disposed on the convex contour will flow towards at least one of the adjacent channels.

17. The pet training pad of claim 1, further comprising an impermeable bottom layer which is impermeable to waste fluid of a pet.

18. The pet training pad of claim 1, wherein the perimeter region surrounds the central region completely as to form a continuous loop around the central region.

19. The pet training pad of claim 1, wherein the pet training pad has a peripheral edge and the perimeter region forms the peripheral edge completely.

20. A method of using a pet training pad, comprising:
obtaining the pet training pad, the pet training pad comprising
a central region;
a perimeter region which surrounds the central region and forms a periphery of the pet training pad;
an absorbent material;
a plurality of sloping channels which slope downward from the perimeter region to the central region; and
wherein the central region has a greater weight of the absorbent material per unit area than the perimeter region;
placing the pet training pad on a planar support surface; and
disposing a fluid on a top surface of the pet training pad such that the fluid flows in at least one of the plurality of sloping channels towards the central region.
